(19) United States
(12) Patent Application Publication
(10) Pub. No.: US 2010/0042339 A1
(43) Pub. Date: Feb. 18, 2010

(54) FLUIDIC ANALYSIS DEVICE FOR DETERMINING CHARACTERISTICS OF A FLUID

(76) Inventors: Arash Dodge, Berne (CH); Pierre Guillot, Pessac (FR); Matthieu Guirardel, Bordeaux (FR); Annie Colin, Bordeaux (FR)

Correspondence Address: BUCHANAN, INGERSOLL & ROONEY PC, POST OFFICE BOX 1404, ALEXANDRIA, VA, 22313-1404, US

(21) Appl. No.: 12/445,219

(22) PCT Filed: Oct. 12, 2007
(86) PCT No.: PCT/FR2007/001669

§ 371 Date: Oct. 27, 2009

(30) Foreign Application Priority Data
Oct. 13, 2006 (FR) 0608994

(51) Int. Cl. G01N 11/06; G01N 11/08

(52) U.S. Cl. 702/50; 73/54.07; 73/54.09

(57) ABSTRACT

A fluidic analysis device includes a small plate (2), at least one flow channel (4) formed in this plate, means (18) for directing a fluid into the flow channel, and at least two analytical means (28′, 28″, 36₁, 36₂ 46) suitable for analyzing a sample of unique composition of said fluid.

The present invention relates to a fluid analysis device, a device allowing characteristics of a fluid to be determined comprising such an analysis device, methods of implementing these devices and a corresponding screening method.

The invention aims to process any type of fluid, namely not only a pure fluid, but also a formulation, namely a fluid chemical system formed of various components. The invention aims more particularly, but not exclusively, to process a formulation of the binary, ternary or quaternary type, or of even higher order, the fractions of the various components of which are able to vary.

The characteristics of a fluid capable of being determined according to the invention are of several types. Without limitation, it is possible to mention in particular physico-chemical properties such as viscosity, or electrical properties such as conductivity. It is also possible to mention optical characteristics relating to the visual appearance of the fluid, in particular relating to the possible presence of different, complex or crystal phases. These characteristics may, in particular, be the result of interactions and/or arrangements of a component of the formulation with itself or of one or more components with one or more others. Thus there are fluids, called complex fluids, comprising a carrier such as water and other ingredients, the components of which arrange themselves in a defined manner, if necessary under the action of an external parameter, for example in the form of micelles of more or less complex shapes, of laminar phases, precipitation phases, physically and/or chemically cross-linked gels, and of which it is wished to evaluate certain characteristics. The characteristics may, in particular, be evaluated with an applied aim for designing new formulations.

Usually, when it is wished to obtain an intended composition range of a formulation, namely that appropriate to a desired use, one proceeds systematically. To this end, several fluid samples of various compositions are successively prepared and measurements are made, the number of which corresponds to that of the samples originally prepared. It will be understood that this approach implies certain shortcomings, in particular to the extent that it proves to take a very long time to implement.

The invention aims more particularly to alleviate this shortcoming.

To this end, its subject is a fluid analysis device according to the appended claim 1.

Further advantageous features of this device are the subject of the appended claims 2 to 23.

The subject of the invention is also a device for determining characteristics of a fluid according to the appended claim 24.

The subject of the invention is also a method for implementing the above analysis device according to the appended claim 25.

Further advantageous features of this method are the subject of the appended claims 26 to 29.

The subject of the invention is finally a method for screening several fluids according to the appended claim 30.

Further advantageous features of this screening method are the subject of the appended claims 31 and 32.

The invention will be described below with reference to the appended drawings, provided solely by way of nonlimiting example, in which:

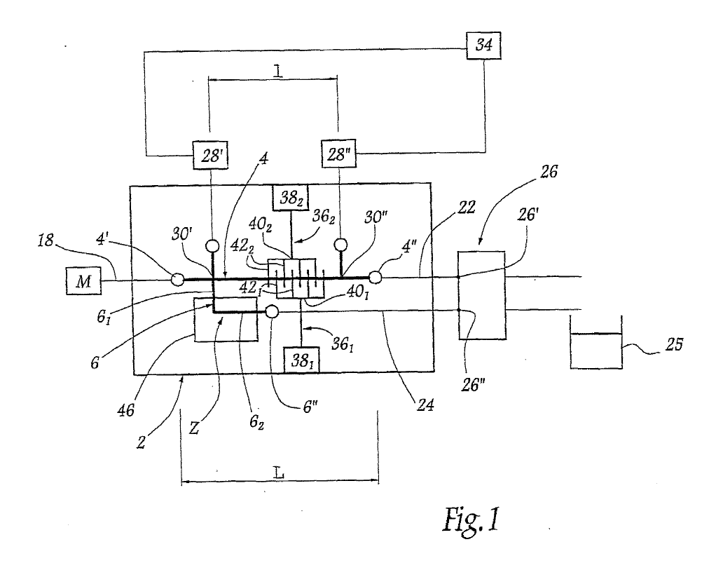

FIG. 1 is a front elevation schematically illustrating an analysis device belonging to a device for determining characteristics of a fluid according to the invention;

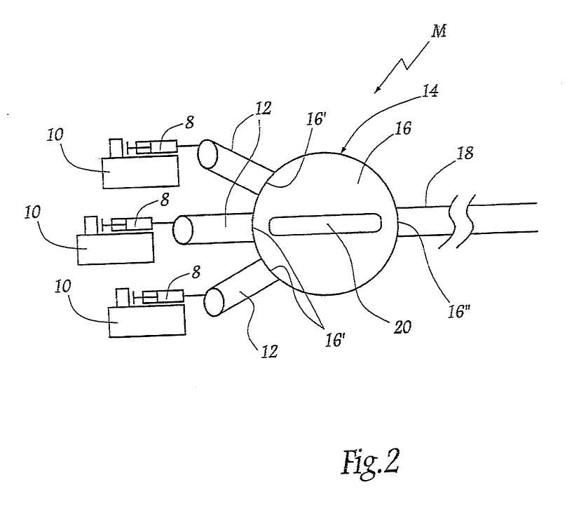

FIG. 2 is a front elevation illustrating means for preparing various formulations, intended to be associated with the analysis device of FIG. 1;

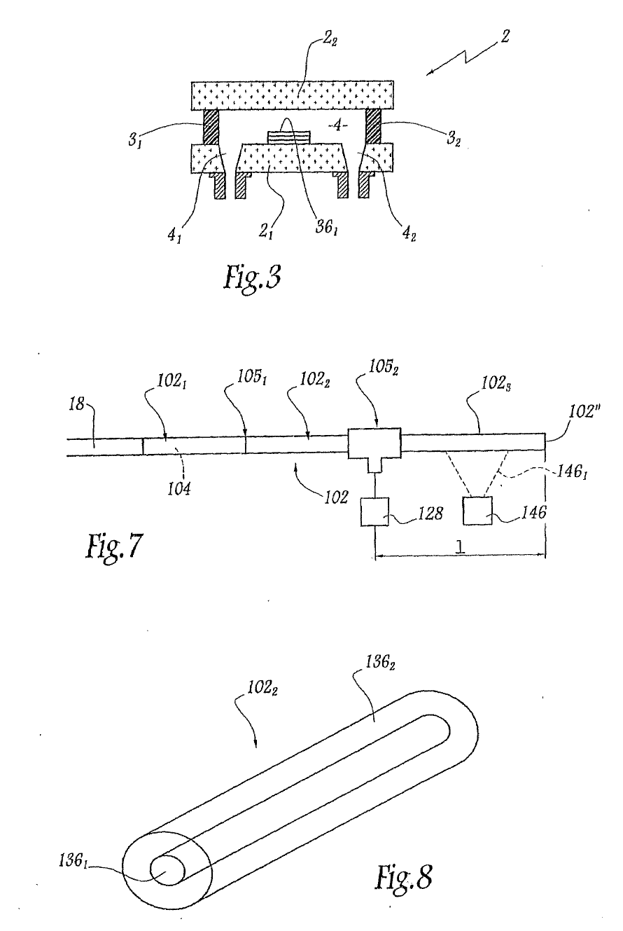

FIG. 3 is a cross section illustrating a microchannel formed in a plate belonging to the analysis device of FIG. 1;

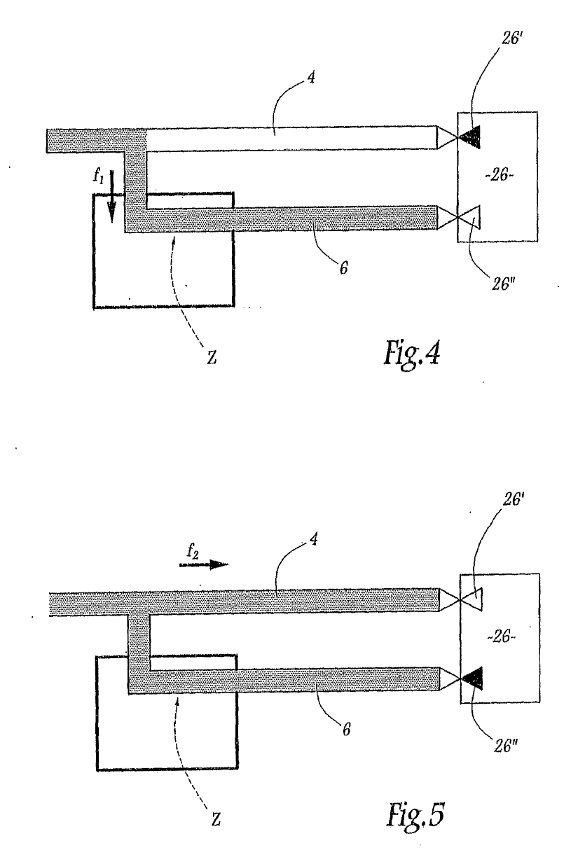

FIGS. 4 and 5 are two front elevations similar to FIG. 1 but at larger scale, illustrating the implementation of the device for determining characteristics according to the invention;

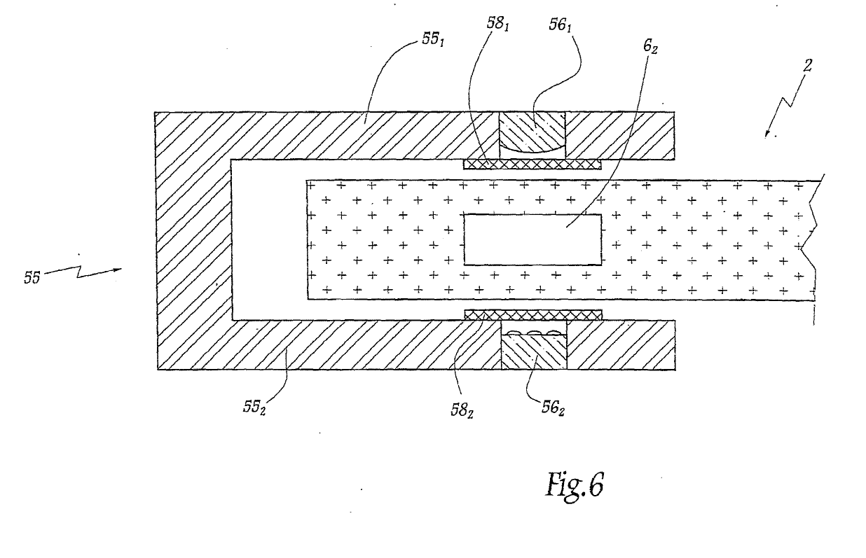

FIG. 6 is a cross section illustrating a variant embodiment of optical analysis means according to the invention;

FIG. 7 is an elevation similar to FIG. 1, illustrating a variant embodiment of a device for determining characteristics according to the invention; and

FIG. 8 is a perspective view illustrating in greater detail a conductivity measurement section belonging to the device of FIG. 7.

The determination device according to the invention comprises first of all an analysis device, illustrated in particular detail in FIG. 1. The analysis device comprises first of all a plate 2, made from glass, in which various microchannels are formed in accordance with procedures which will be described in greater detail in the following. In FIG. 1 the microchannels engraved in the plate 2 are represented using thick lines, while the tubes connected to these microchannels are represented using thinner lines.

In the example illustrated, the characteristic cross sectional area of these microchannels is typically between 100 μm² (for example 10 μm by 10 μm) and 1 mm² (for example 1 mm by 1 mm). This size typically causes approximately laminar flow within these microchannels, with a Reynolds number clearly less than 100. By way of indication, to illustrate the properties of these microchannels, the work by Stéphane COLIN may be mentioned, Microfluidique (EGEM Microsystems series, published by Hermes Sciences Publications).

It will, however, be noted that, by way of a variant, the invention can also be applied to microfluidic flow channels, that is channels whose cross section is greater than the values mentioned above. Thus, the cross section of these millifluidic channels may reach a value close to 25 mm², or 5 mm by 5 mm for example.

More precisely, a first microchannel, called the flow microchannel 4, is first of all hollowed out in the plate 2. This microchannel 4, which extends horizontally in this FIG. 1, has an inlet 4′ and an outlet 4″. Its length, denoted L, is for example between 5 mm and 3 m, preferably between 1 cm and 10 cm.

A derivate microchannel 6 is etched on the flow microchannel 4, close to the inlet 4′ of the latter. This derivate microchannel 6, which has a vertical branch 6₁ and a horizontal branch 6₂, is associated with an outlet 6″.

The determination device according to the invention also comprises means for preparing various formulations, represented schematically in FIG. 1, where they are allocated with the reference M, and illustrated in more detail in FIG. 2. These preparation means M comprise first of all various syringes 8, three in number in FIG. 2, which are associated with syringe pumps 10. These syringes and these syringe pumps are of a type known per se, so that they will not be described in greater detail in the following.

Each syringe 8 is caused to interact with a corresponding tube 12, which opens into a mixing element 14. The latter comprises a chamber 16 provided with several inlets 16′, which are connected to the tubes 12, and an outlet 161″, associated with a feed tube 18 extending in the direction of the inlet 4′ of the flow microchannel 4. Finally, the chamber 16 accommodates an agitation element 20, of a type known per se, which is for example magnetic in nature.

With reference once again to FIG. 1, the respective outlets 4″ and 6″ of the microchannels 4 and 6 are connected to discharge tubes 22 and 24, which themselves open out into an effluent collection container 25. These two tubes 22 and 24 are associated with a solenoid valve 26 provided with two inlets 26′ and 26″, each of which is located on a respective tube 22 or 24.

Two pressure sensors 28′ and 28″, of a type known per se, are provided respectively close to the inlet 4′ and the outlet 4″ of the flow microchannel 4. The points, respectively upstream and downstream, at which these sensors are positioned are denoted 30′ and 30″. The latter are furthermore connected to a processing computer 34.

In a median area of the flow microchannel 4, situated between the aforementioned points 30′ and 30″, the device of the invention is provided with means for analyzing conductivity. The latter comprise two electrodes 36₁ and 36₂, each of which has a block 38₁, 38₂ extended by a T-shaped branch 40₁, 40₂.

Various fingers 42₁, 42₂ extend from these branches 40₁, 40₂ in an alternating manner. In other words, one finger connected to a considered branch is surrounded by two fingers connected to the other branch. The electrodes 36₁ and 36₂ are connected to the computer 34 in a manner not represented.

The constitutive material of the electrodes 36₁ and 36₂ is for example a gold deposit on a chromium deposit, or a platinum deposit on a tantalum deposit having a thickness of a few tens of nanometers and a width of between 10 and 500 micrometers or microns. The blocks 38₁ and 38₂ of these electrodes are connected to an impedometer 44, of a type known per se, which is itself connected to the processing computer 34.

The device of the invention is provided with analysis means other than viscosity analysis.

It may for example be spectroscopic analysis means, for example by X-ray fluorescence, X-ray diffusion, UV spectroscopy, infrared spectroscopy, Raman spectroscopy.

The device according to the invention may notably be provided with thermal analysis means, for example of the calorimetry type.

The device according to the invention may in particular be provided with conductivity analysis means.

The device according to the invention may in particular be provided with means of optical analysis. It may in particular be a measurement of the diffusion of light, of dynamic diffusion of light, of birefringence, or of turbidity. It is also possible to carry out a thermal analysis, for example of the calorimetry type.

The means of optical analysis comprises a microscope 46, represented schematically, which is provided with two polarizers, of a type known per se. These two polarizers are located on both sides of the horizontal branch 6₂ of the derivate microchannel 6, with a view to the implementation of the device of the invention, as will be seen in more detail in the following. The observation area of the microscope 46 is denoted Z, which microscope is itself associated with photographic apparatus that is not shown, connected to the processing computer 34 which is also not shown.

FIG. 3 illustrates a sectional view of the plate 2, also making the flow microchannel 4 and one of the electrodes 36₁ apparent.

The plate 2 is produced from a first plate of glass 2₁ on which the electrode 36₁ is fitted. To this end, various layers of chromium, gold and an NOA 81 resin are firstly fitted. Part of the three layers thus deposited is then removed, by any appropriate method, so as to leave only the electrode 36₁ subsisting on the surface of the plate 2₁.

Various access holes are then formed in the plate 2₁, of which only two 4₁ and 4₂ are shown, by a sandblasting method known per se. These holes, which have a cone shape, are hollowed out from the side of the plate where the electrodes are inserted.

An upper plate 2₂ is then fitted a distance from the lower plate 2₁ with two lateral spacers interposed which are also made of glass, which makes it possible to determine the height of the channels. The intermediate space between the two plates is filled using an NOA 81 resin, then a transparent photolithographic mask is introduced, which mask contains the design of the network of channels.

This resin is then polymerized while transferring to it the aforementioned channel design. Finally, the spacers (not shown) are removed so that the lateral walls of the microchannel 4 are formed by the portions 3₁ and 3₂ of the polymerized resin.

The use of the device according to the invention described above will now be explained in the following.

It is assumed that a fluid consisting of several components is to be treated. In a first period it therefore involves producing this formulation before admitting it to the inlet 4′ of the flow microchannel 4.

To this end, the various components are delivered, by means of syringes 8, in the direction of the chamber 16 of the mixing element 14. It will be noted that usually the more the flow rate of a given component is increased, the more its concentration within the final formulation is also increased. The presence of the agitator 20 contributes to homogenizing the various components so that, downstream of the chamber 16, the tube 18 makes it possible to deliver a well-mixed formulation into the flow microchannel 4.

This formulation then flows into this microchannel 4, at a flow rate of between 1 μl/h and 10 ml/min, in particular between 10 μl/h and 1 ml/min. At the beginning of this flow phase, the inlet 26′ of the outlet valve 26 is open while the inlet 26″ of the latter is closed so that the fluid flows only into the microchannel 4 but not into the microchannel 6. Simultaneous viscosity and conductivity measurements are then carried out.

For the viscosity analysis the two sensors 28′ and 28″ are used, which deliver, in a manner known per se, a voltage which depends on the pressure exerted on a piezoresistive material. The computer 34, to which this measurement is transmitted, then converts this voltage into a differential pressure in a manner also known per se. Thus the sensors send electrical voltages to the computer, which multiplies them by a given factor specific to these sensors, which makes it possible to obtain the pressure of each sensor. Finally, one pressure is subtracted from the other pressure, which yields the pressure difference between the two sensors.

By mathematical calculation, the computer then determines the viscosity of the fluid flowing in the microchannel 4. This viscosity calculation involves various parameters which are either fixed a priori or determined in real time. This viscosity depends in particular on the nature of the cross section of the microchannel 4.

Thus in the case in which this microchannel 4 is of rectangular cross section, the viscosity η is equal to:

η=H³wΔP/12Ql

where H is equal to the height of the cross section of the microchannel, w is the width of the microchannel, ΔP is the pressure difference determined by the computer 34, as seen above, Q is equal to the flow rate of the fluid in the microchannel 4, and l is equal to the distance between the upstream 30′ and downstream 30″ points.

In the case of a flow microchannel 4 of circular cross section, the viscosity η is given by the formula:

η=ΔP*π*R⁴/8Ql

where R is the radius of the microchannel, ΔP, Q and l being defined above.

The conductivity measurement is obtained using the electrodes 36₁ and 36₂, associated with the processing computer 34. The electrodes are connected to an impedometer which measures the impedance of the fluid in Siemens by considering a circuit in parallel. The response of the electrodes is moreover calibrated, in conventional manner, in order to obtain the real conductivity. The impedometer measures the resistance R of the fluid, then the computer carries out the inverse calculation 1/R, that is the conductivity value.

Apart from the viscosity and conductivity measurements, an optical measurement of the fluid sample flowing in the device is carried out. It should be noted that the various measurements listed above, namely of viscosity, conductivity and of the optical nature, may be implemented in any order.

In order to carry out the optical measurement, as FIGS. 4 and 5 illustrate, the state of the inlets 26′ and 26″ of the solenoid valve 26 is first of all changed. In these conditions the inlet 261 is from now on closed, while the inlet 26″ is from now on open, as shown in FIG. 4. This then enables the derivate microchannel 6 to be filled using the fluid sample to be studied, while stopping the flow in the microchannel 4. This fluid is therefore from now on present at the right of the observation area Z.

Next, as shown in FIG. 5, the state of the inlets 26′ and 26″ is again switched, so that the inlet 26″ is reopened and the inlet 26″ closed again. The fluid present in the derivate channel 6 is then allowed to stabilize by observing a corresponding stabilization period, the length of which is, for example, between 1 and 60 seconds.

At the end of this period, the fluid is substantially stationary, which guarantees high precision to the optical measurement that is then carried out. The movements of the fluid during the various operations, described above, are marked by the arrows f₁ and f₂. It should be highlighted that filling the derivate channel, in an independent manner, makes it possible to use a small quantity of the fluid to be processed.

The photographic apparatus coupled to the microscope then ensures, in a manner known per se, viewing of the fluid sample through the observation area Z. It will be noted that the two polarizers used in this implementation allow visual differentiation of the phases. Recall that a polarizer filters the light and therefore only allows a single component thereof to pass in a well defined direction.

Consequently, by placing a polarizer on each side of the derivate channel 6, in a crossed manner, all light is prevented from passing through when the fluid has a homogeneous structure. Conversely, when the fluid has an inhomogeneous structure, in particular laminar and/or spherulitic, it is possible to observe luminous variations using microscopy.

At the end of the implementation of the steps described above it will have been possible to determine three characteristics of the fluid to be studied, namely its viscosity, its conductivity and its visual appearance.

The series of steps described above is then recommenced while analyzing a formulation having the same initial components but in different proportions. To this end, the flow rate of these components admitted into the mixing chamber 16, via the tubes 12, is modified.

The same steps are carried out iteratively for an entire range of proportions of the basic components of the formulation. At the end of the screening procedure thus implemented it is then possible to identify at least one advantageous composition of this formulation depending on the intended application.

FIG. 6 illustrates a variant embodiment of the invention relating more specifically to the means of optical analysis.

The plate 2, partly represented, is again found in FIG. 6, along with a section of the horizontal branch 6₂ of the derivate microchannel 6. A support 55 is furthermore provided which is suitable to be joined to the plate 2 by any appropriate means, in particular by interlocking. This U-shaped support 55 has two arms 55₁ and 55₂ which overlap the edge of the plate 2.

One 55₁ of these arms supports a light source 56₁, for example an LED (Light Emitting Diode) or laser light source, while the other arm 55₂ supports a light-intensity detector 56₂, for example a photodiode detector. The source 56₁ and the detector 56₂ are located facing each other, on either side of the branch 6₂.

In addition, two crossed polarizers 58₁ and 58₂, of a type known per se, are placed between the plate and each arm 55₁ and 55₂ of the support 55. These polarizers are, for example, joined to the support, by any appropriate means. The detector 56₂ is connected to a computer (not shown), allowing the signal coming from this detector to be recovered and computationally processed.

The embodiment of FIG. 6 makes it possible, in a manner known per se, to obtain the birefringence values of the fluid flowing in the microchannel 6. By way of a variant (not shown), it is possible not to use the polarizers 58₁ and 58₂. In these conditions, it is then possible to obtain the turbidity values of this fluid.

The embodiment of FIG. 6 has specific advantages. Thus it first of all has a simple mechanical structure as the support 55 provided with optical means 56₁ and 56₂ can be fixed to the plate, in particular in a removable manner. In addition, the use of a light source, associated with a light-intensity detector, makes it possible to obtain a signal continuously.

FIG. 7 illustrates a variant embodiment of the invention. In this figure the feed tube 18 opens into a tubular flow element 102, the internal volume of which forms a flow channel 104, the dimensions of which are similar to those of the channel 4 formed in the plate 2.

In the sense of the invention, such a tubular flow element is an elongate flow element with a closed cross section, the transverse profile of which may have any type of shape, in particular oval or square. Thus, in contrast to the first embodiment, such an element is not formed in a bulky body. The flow channel of the fluid to be analyzed is therefore formed by the internal volume of the tubular flow element.

This tubular flow element 102 has different sections, allowing different types of analysis. Thus a first section 102₁ is again found here which opens into a connector 105₁ connected to a second section 102₂, enabling the conductivity measurement, which is illustrated in more detail in FIG. 8. This section is formed of two concentric electrodes, the internal electrode 136₁ of which is a needle made, for example, of stainless steel. Moreover, the external electrode 136₂, which forms the external wall of the section 102₂, is also made of stainless steel. These two electrodes 136₁ and 136₂ are held relative to one another using the connector 105₁ and a T-shaped joint 105₂.

The electrodes 136₁ and 136₂ are connected to a processing computer (not shown). In the same way as explained with reference to the first embodiment, the flow of the fluid in the vicinity of these two electrodes makes it possible to determine a conductivity value.

The open end of the joint 105₂ is connected to a pressure sensor 128, similar to those 28′ and 28″ of the first embodiment. The second embodiment differs from that described with reference to FIG. 1 in that a single pressure sensor is provided, to the extent that use is also made of atmospheric pressure.

Thus if the tubular element 102 is assumed to be of circular cross section, the viscosity η is given by the following formula, already introduced above:

η=ΔP*π*R⁴/8Ql

where R is the radius of the tubular element 102, ΔP is the pressure difference between the pressures P₁ measured by the sensor 128 and atmospheric pressure, Q is equal to the flow rate of fluid in the tubular element 102, while l is equal to the distance between the point at which the sensor 128 is introduced and the outlet 102″ of the tubular element 102.

Finally, downstream of the T-shaped joint, the tubular flow element 102 comprises a third section produced in the form of a tube 102₃ made of a plastic permeable to X-rays. This tube is thus, for example, made of Kapton. This section 102₃ is associated with an optical analyzer 146 using an X-ray beam 146₁. This makes it possible to produce a view of the fluid sample through the tube 102₃.

The invention is not limited to the examples described and represented.

Thus, it is possible, first of all, to envisage carrying out only a viscosity analysis by means of one or another of the devices described in the preceding figures. In these conditions, the subject of the invention is then a fluid analysis device comprising at least one flow channel, formed in a plate and/or formed by the internal volume of a tubular element, means of feeding this fluid into the channel, along with a means of analyzing the viscosity of the fluid.

It is also possible to provide for a first part of the flow channel to be formed in a plate, as in FIG. 1, while another part of this channel is formed by the internal volume of a tube, as in FIGS. 7 and 8. Thus it is possible, for example, to carry out the viscosity and conductivity analyses within the plate and the optical analysis within the tube.

It is also possible to envisage providing the determination device according to the invention with heating means. The latter, which are conventional in type for example, are associated with the plate or with the tube, and/or with the mixing means.

By way of an additional variant (not shown), it is possible to identify the presence of different phases from the conductivity analysis. Thus, by observing a possible instability in the conductivity value, it is possible to conclude the presence of different phases, in particular of plugs such as drops or bubbles.

The invention makes it possible to carry out a viscosity analysis, so as to obtain in particular the viscosity as a function of the composition of a formulation, and/or as a function of a shear applied to the formulation, and/or as a function of the temperature, and/or as a function of ageing.

The invention also makes it possible to carry out another analysis, for example a spectrometric, optical, calorimetric and/or conductometric analysis.

The various operations, described above, may be controlled by a data processing means, of the computer type. In these conditions, this computer is used to program the various formulations and to control the syringe pumps with a view to ensuring this formulation sequence automatically.

Furthermore, automatic acquisition is carried out of the measurements obtained by the pressure sensors, along with calculation of the viscosity for each formulation. Automatic image and conductivity measurement acquisition is also employed. All the information thus obtained is stored in a results file.

The invention makes it possible to attain the previously mentioned objectives.

Specifically, the various means of analysis with which the device according to the invention is equipped make it possible to obtain quickly several measurements of a fluid sample (a formulation) having the same composition. Furthermore, the composition of the fluid to be studied may be simply and quickly modified.

The invention may therefore be employed in the context of the design of novel products intended to be used as an ingredient in formulations. The invention may also be employed in the context of the design of novel formulations comprising novel associations of ingredients (or associations in novel quantities).

In these conditions the screening method that is capable of being implemented according to the invention is clearly more advantageous than those of the prior art insofar as it comes with significantly improved speed of execution. In this respect, it may be considered that such a screening method may be implemented between 2 and 10 times faster than the prior art.

Finally, it should be noted that, thanks to the invention, a limited quantity of fluid is used. This is advantageous not only in economic terms, but also in environmental terms and in terms of user safety.

The invention may, according to another application, be employed in the context of industrial production checking.

The device is particularly useful for identifying and/or designing compounds and/or formulations used in the following fields:
coating formulations, for example paints;
fluid formulations for the extraction of oil and/or gas;
formulations employed in building and civil engineering;
cosmetic formulations, especially comprising structured phases, in particular Structured Surfactant Liquids (SSLs);
detergent formulations for domestic care, especially comprising structured phases;
phytosanitary formulations; and
products for encapsulation and/or protection and/or release of active compounds, especially in the fields of pharmacy and/or animal care.

The invention is particularly advantageous for the study of surfactants, polymers and/or formulations, often aqueous formulations, comprising one or more surfactant(s) and/or one or more polymer(s) and, as appropriate, other additives such as salts. In the case of the viscosity and conductivity and optical analyses, especially birefringence analyses under polarized light, the invention may very advantageously be used to study and/or design structured formulations comprising an association of several surfactants, optionally at least one polymer and optionally salts. In particular it makes it possible to identify systems based on surfactants and/or polymers having:
a smooth rheology appreciated by consumers;
an ability to suspend and/or the stabilization of solid, liquid or gaseous particles, and/or of liquid phases constituting stripes or other geometric forms in an aqueous formulation, the liquids possibly being in particular oils. It furthermore makes it possible to identify aqueous systems of structured surfactants, possibly comprising salts, having an effective structuration rate (for example with at least 40% by volume of structured phases, preferably at least 75%, more preferably still at least 95%), with a suitable rheology and a suitable suspending power (rheological threshold). Without wanting to be linked with any theory, it is thought that the structuration is due to the formation of spherulitic and/or laminar phase arrangements (observable by optical means) that change the rheology and the conductivity (by incorporating more or less salts and/or water into the structure and/or by changing the mobility of these species). The invention makes it possible to simply and quickly identify such systems or to obtain information capable of suggesting changes in formulation to be carried out in order to obtain such systems.

An example of the implementation of the invention will now be described in the following.

Various ternary formulations are produced from a silicone oil with a viscosity of 200 cP, water and a surfactant. These various formulations are caused to flow into a plate, the flow channel of which has a cross section of 1 mm by 1 mm and a length of 43 mm, between two pressure sensors. Furthermore, crossed polarization microscopy measurements along with conductivity measurements are carried out in this plate.

The flow channel of this plate is connected with a tube made of Kapton, the radius of which is 1.2 mm and the length of which is 10 cm, with a view to X-ray measurement. All these measurements are carried out while causing the various formulations to have a flow rate of 2000 μl/h.

Furthermore, a micromixer is made, placed upstream, from PMMA and a structured plate made of stainless steel, with a view to possible heating. A joint made of Viton seals the two parts of the mixer. Furthermore, in the chamber, a magnetic bar is used of 8 mm length and 1 mm diameter, turning at a rotational speed of 50 revolutions per minute.

Table 1 contains the conductivity values in μS (micro Siemens) placed within a ternary diagram. Furthermore, table 2 contains the viscosity values in cP within the same diagram. Furthermore, various shots are taken using the crossed polarization microscope associated with the plate. An X-ray diffraction measurement is also carried out in the tube made of Kapton. The results agree with those expected in the context of measurements carried out conventionally.

TABLE 1

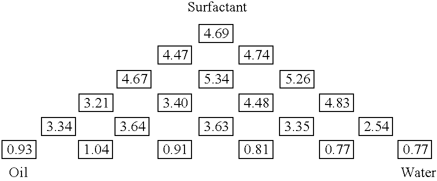

TABLE 2

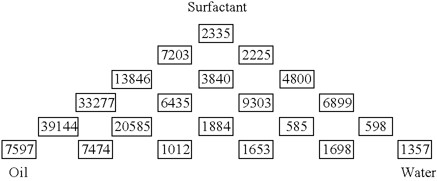

1.-32. (canceled)

33. A fluid analysis device comprising:
at least one flow channel (4) for a fluid to be analyzed;
means (12, 14, 18) for introducing said fluid into the flow channel;
a first analysis means (28′, 28″) adapted to analyze the viscosity of a first sample of said fluid; and
at least one other analysis means (36₁, 36₂, 46; 56₁, 56₂) different in kind from said viscosity analysis means, adapted to analyze said first sample of said fluid or another sample of the same composition as said first sample.

34. The device as defined by claim 33, wherein the cross-section of the flow channel (4) ranges from 100 μm² to 25 mm².

35. The device as defined by claim 34, wherein the flow channel is a microchannel (40), the cross-section of which ranges from 100 μm² to 1 mm².

36. The device as defined by claim 33, wherein the flow channel (4) has a length (L) ranging from 5 mm to 3 meters.

37. The device as defined by claim 33, wherein the viscosity analysis means comprises a single pressure sensor (128) located at a point on the flow channel (104).

38. The device as defined by claim 33, wherein the viscosity analysis means comprises two pressure sensors (28′, 28″) located at two points (30, 30″) at a distance from the flow channel (4).

39. The device as defined by claim 33, provided with at least two other means of analysis.

40. The device as defined by claim 33, wherein said other means of analysis is (are) selected from among means for analyzing conductivity (36₁, 36₂) and optical analysis means (46; 56₁, 56₂).

41. The device as defined by claim 39, wherein the conductivity analysis means comprises at least two electrodes (36₁, 36₂) adapted to come into contact with the fluid to be analyzed.

42. The device as defined by claim 38, wherein the electrodes (36₁, 36₂) are located in a median area between the two points (30′, 30″) at which the pressure sensors (28′, 28″) are located.

43. The device as defined by claim 40, wherein the optical analysis means comprises a microscope (46) including at least one polarizer (48₁, 48₂) located facing an observation area (Z) for observing the fluid to be analyzed.

44. The device as defined by claim 40, wherein the optical analysis means comprises a light source (56₁) and a light-intensity detector (56₂) positioned on either side of an area (Z) for observing the fluid to be analyzed.

45. The device as defined by claim 43, wherein two polarizers (48₁, 48₂; 58₁, 58₂) positioned on either side of the observation area (Z) are provided.

46. The device as defined by claim 43, wherein the observation area (Z) is situated in a channel (6) connected to the flow channel (4).

47. The device as defined by claim 44, wherein the light source (56₁) and the light-intensity detector (56₂) are mounted on a support (55) that is adapted to be fixed, optionally in a removable manner, to the plate (2).

48. The device as defined by claim 39, wherein the optical analysis means comprises an analyzer (146) provided with an X-ray beam (146₁) which is located facing a section (102₃) permeable to X-rays bordering a part of the flow channel.

49. The device as defined by claim 33, wherein the fluid to be analyzed is a mixture and the device furthermore comprises means (14) for forming this mixture, provided upstream of the flow channel (4).

50. The device as defined by claim 49, wherein the means (14) for forming the mixture comprises a chamber (16) including several inlets (16′) interacting with means (8, 12) for admitting the components of the mixture, an agitation element (20), optionally magnetic, accommodated in the chamber, along with an outlet (16″) for the mixed fluid in the direction of the flow channel (4).

51. The device as defined by claim 50, wherein the means (8, 12) for admitting the components of the mixture are associated with means (10) for regulating the flow rate of these components to produce several mixtures of different composition.

52. The device as defined by claim 33, wherein at least part of the or of each flow channel (4) is formed in a plate (2).

53. The device as defined by claim 41, wherein the two electrodes (36₁, 36₂) are positioned on a wall of said plate (2), bordering the flow channel (4).

54. The device as defined by claim 33, wherein at least part of the or of each flow channel (104) forms the internal volume of a tubular flow element (102).

55. The device as defined by claim 41, wherein one (136₁) of the two electrodes is located in the internal volume of a section (102₂) of the tubular flow element (102), optionally centrally, while the other electrode (136₂) forms a wall of the section of this tubular flow element.

56. A device for determining characteristics of a fluid, comprising at least one analysis device as defined by claim 33, and processing means (34) connected to various analysis means (28′, 28″, 36₁, 36₂, 46), these processing means being suited for processing data emanating from the analysis means for determining the viscosity, as well as at least one other characteristic of said fluid.

57. A method of implementing the analysis device as defined by claim 33, in which the fluid is caused to flow into the flow channel, and optionally into the channel (6), and this fluid is analyzed by means of the analysis means (28′, 28″, 36₁, 36₂, 46).

58. The method as defined by claim 57, wherein the fluid is caused to flow in the flow channel (4), and optionally the channel (6), at a flow rate ranging from 1 μl/h to 10 ml/min.

59. The method as defined by claim 57, wherein the flow of the fluid in the flow channel (4) is stopped, this fluid is caused to flow into the channel (6), the fluid present in this channel (6) being made stationary and an optical analysis of the fluid thus made stationary in the channel (6) is carried out.

60. The method for implementing the determination device as defined by claim 57, in which said fluid is analyzed and the viscosity and at least one other characteristic of the fluid are determined from the data provided by the analysis means.

61. The method as defined by claim 60, wherein a pressure difference (ΔP) is determined between either the pressures measured by the two pressure sensors (28′, 28″) or the pressure measured by the single pressure sensor (128) and the ambient pressure, and the viscosity of the fluid is determined from this pressure difference, employing the values of at least one geometrical feature of the flow channel, optionally its height and/or its width and/or its radius, the flow rate (Q) of fluid flowing in the channel, and the distance separating either the two pressure sensors or the single pressure sensor (102″) from the flow channel.

62. A method for screening several fluids, in which said several fluids are provided, the characteristics of each fluid are determined according to the method as defined by claim 57, and at least one preferred fluid is identified having a set of at least two preferred characteristics among said several fluids.

63. The method as defined by claim 62, wherein said several fluids have the same components in different proportions.

64. The method as defined by claim 62, wherein the provision of said several fluids is programmed by a data processing means, and an acquisition of said characteristics, relating to the various fluids, is carried out by this data processing means.
